(19) United States
(12) Patent Application Publication
(10) Pub. No.: US 2015/0314479 A1
(43) Pub. Date: Nov. 5, 2015

(54) METHOD FOR CASTING CONCRETE PRODUCTS

(71) Applicant: Elematic Oy Ab, Akaa (FI)

(72) Inventor: Jani EILOLA, Lempaala (FI)

(73) Assignee: Elematic Oy Ab, Akaa (FI)

(21) Appl. No.: 14/704,026

(22) Filed: May 5, 2015

(30) Foreign Application Priority Data
May 5, 2014 (FI) 20145407

(51) Int. Cl. B28B 15/00; B28B 5/00; B28B 17/00

(52) U.S. Cl. CPC B28B 15/00; B28B 17/0081; B28B 5/00

(57) ABSTRACT

Method for casting concrete products, in which method concrete products are cast with a circulating line casting process where mold tables are transferred from one workstation to another, and in which circulating line casting process a plurality of casting molds are formed and equipped on a mold table, wherein the molds of the products to be cast are divided on a different mold tables so that the differences in total complexity of the molds on a single mold table are minimized between mold tables.

This application claims benefit of Finnish Patent Application No. 20145407, filed 5 May 2014, the entire contents of which are incorporated herein by reference for all purposes.

### BACKGROUND

1. Field

The present disclosure relates to casting concrete products in molds with a circulating line casting process. More precisely the present disclosure relates to a method for casting concrete products utilizing a circulating line casting process comprising a plurality of mold tables movable between different workstations.

2. Description of Related Art

Circulating line casting process is a casting process where the mold tables, on which the casting molds are built, are mounted on tracks and circulate through the phases of the casting process, after which the mold tables are returned for a new cycle.

The circulating line is formed of a plurality of workstations between which the casting mold is transferred in different stages of the casting process. In the first stage of the circulation line the mold table is cleaned. In next stage the mold table is furnished with fixed and detachable mold sidewalls to form the casting mold in the mold table and other required equipment, such as reinforcements etc., are set on the mold. After the furnishing stage casting of the concrete mass to the mold is carried out, together with required vibrating actions during the casting. The casting of concrete mass into the mold can be carried out in different stages if for example different layers need to be added to the product to be cast such as insulation layers in cases of insulated wall elements. When casting of concrete mass to the mold is done, the upper surface of the product to be cast is leveled and other required surface treatment steps are carried out. Next the mold together with the fresh cast product is moved to curing stage, which generally takes place at a curing chamber where temperature during the curing can be monitored and adjusted if required. When the cast product is cured, the mold is taken to demolding, where the mold sidewalls are removed from the mold table after which the cast product is removed from the mold generally together with tilting of the mold table. After this stage the mold is ready for new cleaning stage and for the process of casting a new product.

The mold tables used in the circulating line casting process are generally large enough to contain molds for a plurality of concrete products. In these cases the molds cover generally about 60-80% of the surface of the mold table, and the aim is to cover as much as possible of the mold table surface with the molds in order to increase the efficiency of the casting process.

Alternatively molds for the products to be cast may be formed on mold tables and cast in the order the cast products are installed on the construction site. This type of solution is disclosed in patent publication EP 2 119 541 B1.

In the forced circulation type processes, such as circulating line casting processes, the working time of each mold or mold table at workstation should be very close to the same, since otherwise there will be congestions before the most complex mold in the process, which follows the most complex mold through the forced circulation process.

### SUMMARY

The present invention, in an embodiment, provides one solution for evening out the complexity of different molds and mold tables, and thus the required work at workstations of the circulating line casting process. This enhances the efficiency of the casting process.

The method of an embodiment of the present invention can also be combined with the prior art mold table filling methods, for example, by evening out the complexity differences of mold tables, but not deviating from the installation order more than two days.

In an embodiment of the present invention, each of the mold tables of a circulation line casting process are equipped with a plurality of molds for concrete products in such a way that the total complexity of the molds in a single mold table is substantially equal, or as closely equal as possible, so that the working time at different workstations of the circulating line casting process for the molds on the mold table is close to the same for all of the mold tables.

The complexity of a mold in this context is defined by the amount of sidewall elements used in forming the mold on the mold table, amount of openings, such as windows and doorways for example, to be formed in the mold, required reinforcements, installation of required electric cable pipes, required steps for forming determined product surface type, use of retarder, etc. In other words, all of the required steps of forming the mold on a mold table prior to casting, and may even include the casting phase.

In an embodiment of the method of the invention, concrete products are cast with a circulating line casting process where mold tables are transferred from one workstation to another, and in which circulating line casting process a plurality of casting molds are formed and equipped on a mold table, wherein the molds of the products to be cast are divided on a different mold tables so that the differences in total complexity of the molds on a single mold table are minimized between mold tables.

In an embodiment of the method of the invention, the complexity of a mold is defined at least by the amount of sidewall elements used for forming the mold on a mold table and by the amount of openings in the mold, as well as the required reinforcements and other works steps for forming and equipping the mold prior to casting.

Additionally or alternatively, previously collected data relating to working times on different workstations of the circulating line casting process for different molds and mold tables may be used for defining the complexity of a mold and mold table.

In this embodiment, for example, the time for forming one opening in a mold is determined from previously collected time data, so that when two similar openings are to be formed to a new mold, the time for forming these two opening can be estimated. This is advantageously carried out by an automatic control system of the circulating line casting process.

In an embodiment of the method of the invention, the amount of molds on different mold tables may vary in order to allow more freedom for adjusting the complexity of different mold tables closer to each other. Thus, some mold tables may only have 2 or 3 complex molds formed on them, when other may have four simpler molds on them.

In an embodiment of the method of the invention, the circulating line casting process is preferably controlled with an automatic control system, which automatic control system defines the complexity of a mold and divides the molds of products to be cast to mold tables. This allows for more automated production processes.

In the embodiment using an automatic control system, the complexity of a mold may preferably be defined by the automatic control system from the electronic designs of the product to be cast. These electronic designs generally comprise at least the outer dimensions of the product to be cast and the dimensions for required openings, which may be used to define the complexity of the required mold. Further, the electronic designs may also comprise other product specific data, such as type of surface to be obtained, location of electronic cabling pipes, etc, to be used in the definition of the complexity of the mold.

The features of a method according to an embodiment of the invention are more precisely disclosed as a method for casting concrete products, in which method concrete products are cast with a circulating line casting process where mold tables are transferred from one workstation to another, and in which circulating line casting process a plurality of casting molds are formed and equipped on a mold table, characterized in that the molds of the products to be cast are divided on a different mold tables so that the differences in total complexity of the molds on a single mold table are minimized between mold tables. Other advantageous features and embodiments of the invention include those wherein:

the complexity of a mold is defined at least by the amount of sidewall elements use for forming the mold on a mold table and by the amount of openings in the mold, as well as the required reinforcements and other work steps for forming and equipping the mold prior to casting;

previously collected data relating to working times on different workstations of the circulating line casting process for different molds and mold tables is used for defining the complexity of a mold and mold table;

the amount of molds on a single mold table may vary between mold tables;

the circulating line casting process is controlled with an automatic control system, which automatic control system defines the complexity of a mold and divides the molds of products to be cast to mold tables; and/or

the complexity of a mold is defined by the automatic control system from the electronic designs of the product to be cast.

### BRIEF DESCRIPTION OF DRAWINGS

Exemplifying embodiment of the invention and its advantages are explained in greater detail below in the sense of example and with reference to accompanying drawings, where

FIG. 1 shows schematically a layout of a manufacturing facility with circulating line casting processes utilizing an embodiment of the present invention, and

FIGS. 2A-2C shows schematically three mold tables equipped with molds in accordance with an embodiment of the invention.

### DETAILED DESCRIPTION OF SPECIFIC EMBODIMENTS

The circulating line casting processes 1, 1′ comprises a plurality of work phases or workstations which are located side by side in the lengthwise direction of the processes in two separate workstation lines, which two workstation lines are connected to each other at transversal transfer tracks 3, 3′ and 4, 4′ located at the both ends of the workstation lines. The mold tables or molds are transferred from one workstation to another along tracks extending along the workstation lines, and from one workstation line to another with the transversal transfer tracks 3, 3′ and 4, 4′.

In the circulating line casting processes 1, 1′, the first work phase carried out in first workstation 5, 5′ is the cleaning of the mold table, after which the mold table is moved to furnishing stage where mold sidewalls are fixed to the mold table to form the casting mold, which is carried out in workstations 6, 6′ and 7, 7′. Once the mold is ready, the required reinforcements are added and installed in the mold in workstations 8, 8′, 9, 9′, 10, 10′ and 11, 11′. Next, the casting of the concrete mass is carried out in workstation 12, 12′, after which the molds with cast products are moved to a curing chamber 13, 13′. In the curing chamber 13, 13′, the molds are stacked in stacks so that a plurality of concrete products in their molds can be cured simultaneously. Further, the curing chamber is also equipped with separate walls to form an enclosed area, and the temperature and humidity inside the curing chamber is modified in order to enhance the curing of the concrete products.

In the circulating line process 1′, the casting of the concrete mass into the mold can also be carried in two stages, first at reinforcements workstation 9′ and then casting workstation 12′. This allows casting of insulated wall elements, for example, where the wall element to be cast comprises an insulation layer that is added on top of the first cast concrete layer before another layer of concrete is cast on top of the insulation layer. Both of these concrete layers in the insulated wall element often also require separate reinforcements for each concrete layer.

Once the concrete products in their molds are cured, the molds are moved out of the curing chamber 13, 13′ to workstations 14, 14′ and 15, 15′ for demoulding, where the mold sidewalls are removed from the mold table. Between the demoulding workstations 14, 14′ and 15, 15′ is arranged additional buffer place 16, 16′, which can alternatively also be used as an additional demoulding workstation. In the last phase, the cured concrete products are removed from the mold table in workstation 17, 17′, which is implemented by tilting the mold table, fixing lifting hooks to lifting lugs located in the products, and lifting the concrete products with a crane from the workstations to a separate removal carriages 23, 23′, the tracks of which are shown in the figure extending from the circulating line casting process lines, and moved to storage. When the cast concrete product is moved from the mold table, the mold table is moved to the workstation 5, 5′ for cleaning and for a new casting process.

The reinforcements added and fixed to the molds are prefabricated in the reinforcement shop 2, and taken to the reinforcement workstations 8, 8′, 9, 9′, 10, 10′ and 11, 11′ of the circulating line casting processes 1, 1′ with carriages 18, 18′, which carriages move along a straight tracks extending from the reinforcement shop to the area inside the circulating line casting processes. There can be more than one carriage located in the same track, as is shown with a carriage 19 in the area located inside the circulating line casting process 1′. The manufacturing facility also comprises bridge cranes 20, 20′, and 21, for lifting and moving reinforcements and other material from the carriages 18, 18′, and 19 to the workstations of the circulating line casting processes 1, 1′.

The circulating line casting processes 1, 1′ are controlled with an automatic control system (not shown), which follows the location of each mold table through suitable identification devices, such as RFID tags for example, so that the automatic control system can provide each workstation with materials required for the work carried out in that work station at correct time.

The mold beds used in the circulating line casting processes 1, 1′ of an embodiment of the invention are large enough to contain a plurality of molds. The size of the mold tables may be 2.5-4.5 m×8-13 m, for example.

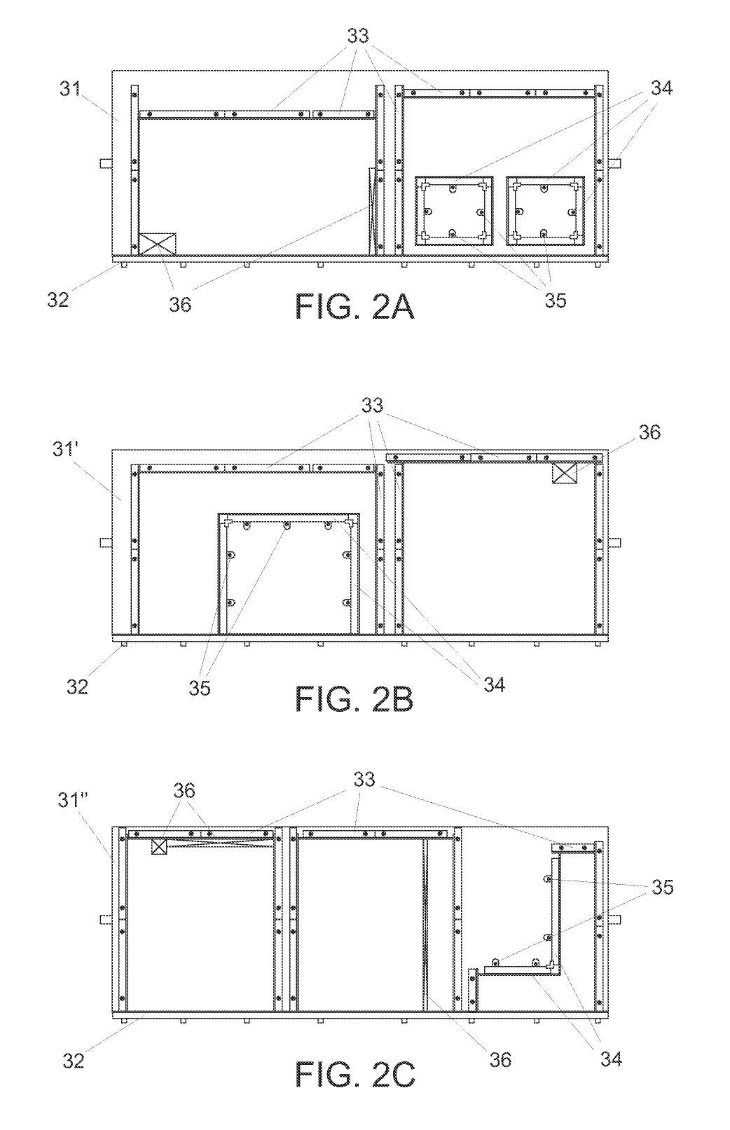

FIGS. 2A-2C show schematically three mold tables 31, 31′ and 31″ equipped with molds in accordance with an embodiment of the invention.

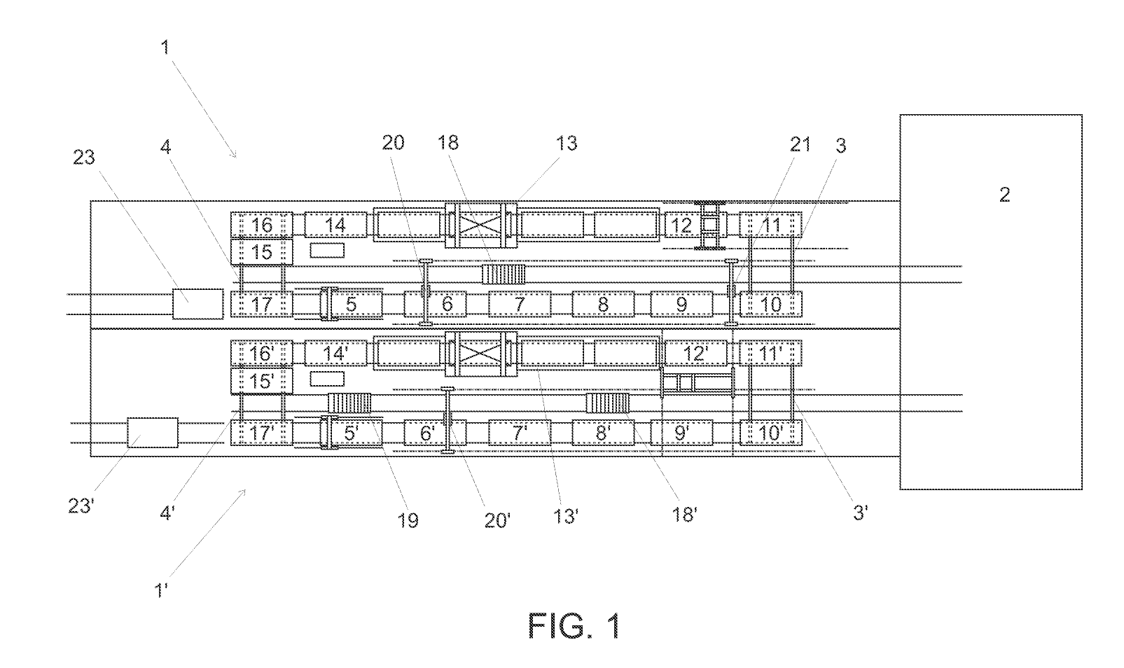

In the mold tables 31, 31′, 31″ is formed a plurality of molds, in this embodiment 2-3, for casting concrete products with a circulating line casting process, such as one shown in FIG. 1.

The mold tables 31, 31′, 31″ are equipped with one fixed mold sidewall 32 extending along the lower edge of the mold table in the orientation of the figures through the whole length of the mold table. The fixed mold sidewall 32 is utilized in forming the molds and detachable mold sidewalls or sidewall units fixed on the mold table 31, 31′, 31″ with magnets are used for forming the other side surfaces of the molds. In the embodiments, sidewall units 33 with magnet units located inside the sidewall unit and sidewall units 34 with separate fixing magnet units 35 are used as detachable mold sidewall units.

Further, the some of the molds are also equipped with additional pieces 36 used to form recesses or depressions to the products to be cast.

The FIGS. 2A-2C illustrates the principle of an embodiment of the present invention, where the complexity of the molds is evened out between the three mold tables 31, 31′ 31″ as far as possible. By combining more complex molds with simpler ones (FIGS. 2A and 2B), or adjusting the amount of molds to be formed on one mold table (FIG. 2C), the complexities between different mold tables may be adjusted to be same, or nearly the same, so that each mold table requires equal or substantially equal amounts of work at workstations of the circulating line casting process.

In this embodiment, the complexity definition is restricted to the formation of the molds on the mold table, which is one of the key factors for defining the total complexity of the mold table through the circulating line casting process and thus for the time required for forming the molds on the mold table at work stations. Other factors affecting the complexity of the molds, such as reinforcements etc. may also be used for the definition of the complexity of the molds.

In FIG. 2A the mold table 31 comprises two molds: one simple mold with two additional pieces 36 added to the mold, and one more complex mold with two window openings. In FIG. 2B the mold table 31′ comprises also two molds: one more complex mold with doorway opening, and one simple mold with only one additional piece 36. In FIG. 2C the mold comprises three molds: two simple molds with additional pieces 36, and one little more complex L-shaped mold.

The specific exemplifying embodiment of the invention shown in figures and discussed above should not be construed as limiting. A person skilled in the art can amend and modify the embodiment in many evident ways within the scope of the attached claims. Thus the invention is not limited merely to the embodiments described above.

1. A method for casting concrete products, in which method concrete products are cast with a circulating line casting process where mold tables are transferred from one workstation to another, and in which circulating line casting process a plurality of casting molds are formed and equipped on a mold table, comprising dividing the molds of the products to be cast on a different mold tables so that the differences in total complexity of the molds on a single mold table are minimized between mold tables.

2. The method according to claim 1, wherein the complexity of a mold is defined at least by the amount of sidewall elements use for forming the mold on a mold table and by the amount of openings in the mold, as well as the required reinforcements and other work steps for forming and equipping the mold prior to casting.

3. The method according to claim 1, further comprising using previously collected data relating to working times on different workstations of the circulating line casting process for different molds and mold tables for defining the complexity of a mold and mold table.

4. The method according to claim 1, wherein the amount of molds on a single mold table may vary between mold tables.

5. The method according to claim 1, further comprising controlling the circulating line casting process with an automatic control system, which automatic control system defines the complexity of a mold and divides the molds of products to be cast to mold tables.

6. The method according to claim 5, wherein the complexity of a mold is defined by the automatic control system from the electronic designs of the product to be cast.
